(19) United States
(12) Patent Application Publication
(10) Pub. No.: US 2019/0316008 A1
(43) Pub. Date: Oct. 17, 2019

(54) STRETCHABLE ELECTRICALLY-CONDUCTIVE ADHESIVE TAPE

(71) Applicant: 3M INNOVATIVE PROPERTIES COMPANY, St. Paul, MN (US)

(72) Inventors: Jeongwan Choi, Kyonggi-Do (KR); Jeffrey W. McCutcheon, Baldwin, WI (US)

(21) Appl. No.: 16/318,486

(22) PCT Filed: Jul. 27, 2017
(86) PCT No.: PCT/US2017/044098

§ 371 Date: Jan. 17, 2019

Related U.S. Application Data
(60) Provisional application No. 62/367,943, filed on Jul. 28, 2016.

(51) Int. Cl. C09J 7/22; C09J 7/21; C09J 7/38; C09J 7/40; C09J 9/02

(52) U.S. Cl. CPC C09J 7/22; C09J 7/21; C09J 7/385; C09J 7/40; C09J 2201/606; C09J 2201/602; C09J 2203/318; C09J 2400/26; C09J 9/02

(57) ABSTRACT

A stretchable conductive adhesive tape comprises an electrically-conductive pressure-sensitive adhesive layer having first and second opposed major surfaces. The electrically-conductive pressure-sensitive adhesive layer comprises electrically-conductive particles and an electrically-conductive stretchable fabric disposed within a polymer matrix. The electrically-conductive pressure-sensitive adhesive layer is electrically-conductive in all directions. An elastic backing is disposed on the first major surface of the electrically-conductive pressure-sensitive adhesive layer.

### TECHNICAL FIELD

The present disclosure broadly relates to electrically-conductive adhesive articles.

### BACKGROUND

Electrically-conductive adhesive tapes are known in the art and are typically used to form electrical connection between electrical components, and also for shielding from electromagnetic radiation interference (EMI). Two common types of electrically-conductive adhesive tapes are heat-activated (e.g., thermosetting conductive tapes) and pressure-sensitive adhesive (PSA) tapes.

As modern electronic devices (e.g., tablet computers, cell phones, and portable computers) have become thinner, they have become more prone to flexing during handling and use, which may cause electrically conductive adhesive tapes used in their construction to exhibit conductivity changes at the interface between the adhesive and the electrical components to which it is attached, thereby causing ElectroMagnetic Interference (EMI) (e.g., with an electronic display). This is especially true in the case of electronic device having liquid crystal displays (LCDs). In this case electrically-conductive adhesive tapes are used for grounding and EMI shielding to protect it from static electricity and noise that damage or affect other electronic components (e.g., integrated circuit chips) associated with the electronic device.

Current commercially available electrically-conductive pressure-sensitive adhesive tapes are not elastically stretchable to an appreciable degree due to the presence of inextensible materials used in their construction (e.g., inextensible fabric or foil components). When an electronic device experiences flexing, the flexing imparts stress-strain into the bonding line of the adhesive at the substrate interface. The adhesive is of a modulus that it cannot resist the stress-strain forces, and is thus displaced by some amount at the adhesive-substrate interface. The displacement leads to a shift in a grounding contact point as the conductive fillers of the adhesive are displaced from the substrate. The displacement can be quite small, but once the flow of current or resistance value for a grounding path is changed due to a displacement, the current flow of the interface must be reestablished and the resistance at that interface changes. The movement at the interface of the conductive fillers leads to a resistance change that leads to EMI noise generation that can interfere with a display or other electronics components, such as a capacitive touch system used in a display design, a WIFI antenna, radio antenna, integrated circuit traces or flexible circuits (carrying information or data) and integrated chips.

### SUMMARY

Accordingly, it would be desirable to have electrically-conductive adhesive tapes that are sufficiently elastically deformable that their electrical bond to electronic components subjected to moderate flexing remains stable.

Advantageously, electrically-conductive adhesive tapes according to the present disclosure provide enhanced electrical stability as compared to currently available, electrically-conductive adhesive tapes. The articles are especially useful as grounding tapes for handheld tablet computers. Due to their elastic stretchable characteristics, the tapes help to minimize the resistance change as little variations of resistance can affect the high performance touch display function of displays. Also, the tapes help protect electronic devices from external stresses and chemical exposure.

In one aspect, the present disclosure provides a stretchable conductive adhesive tape comprising:

an electrically-conductive pressure-sensitive adhesive layer having first and second opposed major surfaces, wherein the electrically-conductive pressure-sensitive adhesive layer comprises electrically-conductive particles and an electrically-conductive stretchable fabric disposed within a polymer matrix, wherein the electrically-conductive pressure-sensitive adhesive layer is electrically-conductive in all directions; and

an elastic backing disposed on the first major surface of the electrically-conductive pressure-sensitive adhesive layer.

In another aspect, the present disclosure provides an electronic article comprising two electrically-conductive components in electrical communication through a stretchable electrically-conductive adhesive tape according to the present disclosure.

As used herein:

the term “elastic” means capable of being deformed to a deformed shape by an applied force and spontaneously returning to its original shape upon removal of the applied force;

the term “fabric” includes woven fabrics, nonwoven fabrics, knit fabrics, and scrims; and

the term “XYZ electrically-conductive” means electrically-conductive in all (e.g., length X, width Y, and thickness Z) directions.

Features and advantages of the present disclosure will be further understood upon consideration of the detailed description as well as the appended claims.

### BRIEF DESCRIPTION OF THE DRAWINGS

FIG. 1 is a schematic side view of an exemplary stretchable electrically-conductive adhesive tape 100 according to the present disclosure.

FIG. 2 is a schematic top view of electrically-conductive stretchable fabric 140 shown in FIG. 1.

FIG. 3 is a schematic top view of an exemplary LCD assembly 300 with stretchable electrically-conductive adhesive tape 100 affixed thereto as an edge wrap according to the present disclosure.

FIG. 4 is a schematic cross-sectional side view of the LCD assembly 300 shown in FIG. 3 taken along line 4-4.

FIG. 5 is a graph of electrical resistance vs. deflection cycles for the stretchable electrically-conductive tape of Example 1.

FIG. 6 is a graph of electrical resistance vs. deflection cycles for the stretchable electrically-conductive tape of Comparative Example A.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Due to the elastic nature of the electrically-conductive stretchable adhesive tapes of the present disclosure, they help minimize the resistance change and little variation of resistance that can deleteriously effect high performance electronic displays and/or other device functions. Also, they may help to protect electronic devices from applied external stress.

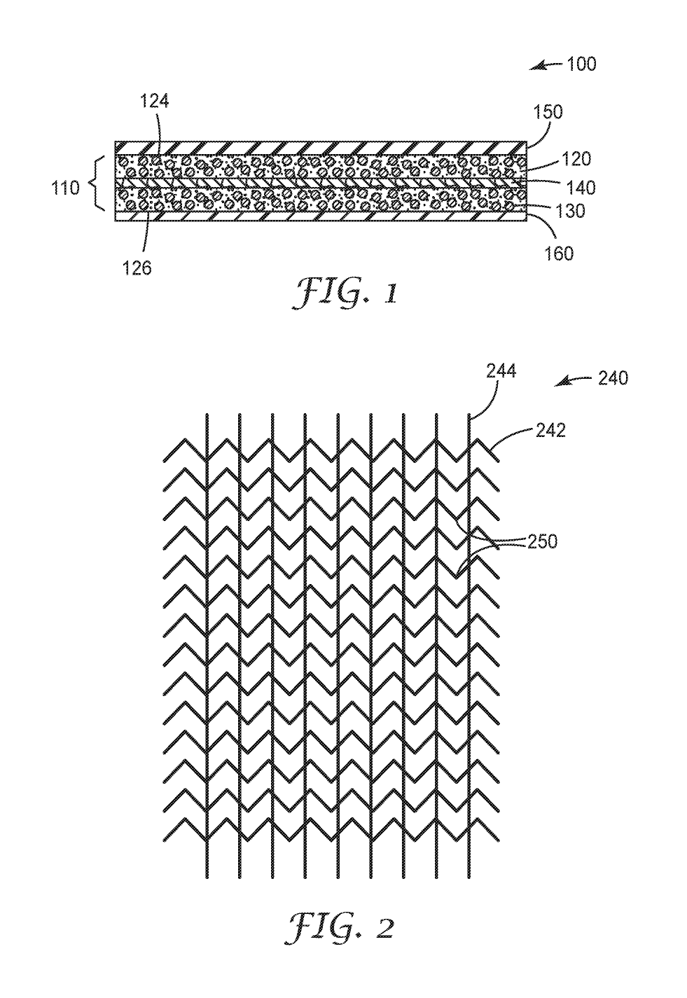

Referring now to FIG. 1, exemplary stretchable electrically-conductive adhesive tape 100 comprises an electrically-conductive adhesive layer 110 comprising an acrylic polymer matrix 120, electrically-conductive particles 130, and an electrically-conductive stretchable fabric 140. Electrically-conductive acrylic adhesive layer 110 has first and second opposed major surfaces (124, 126). Electrically-conductive stretchable fabric 140 and electrically conductive particles 130 are disposed within the electrically-conductive adhesive layer 110. Electrically-conductive stretchable fabric 140 is deformable in at least one dimension without substantially damaging the electrical conductivity of the fabric. Elastic backing 150 disposed on the first major surface 124 of the electrically-conductive adhesive layer 110. Optional release liner 160 may be adhered to the second major surface 126.

Referring now to FIG. 2, exemplary electrically-conductive stretchable fabric 240 has metallized polyester warp fibers 244 and metallized polyester weft fibers 242 with crimps 250 (e.g., crimps) that allow extension of the fabric and correspondingly in a stretchable electrically-conductive adhesive tape when the longitudinal fibers are aligned lengthwise to the tape without compromising the electrical conductivity of the conductive fabric. This is in contrast to a traditional woven fabric with warp threads aligned longitudinally and weft threads aligned widthwise, where stretching of the expansion of the tape width is not possible without stretching and/or breaking the weft threads and compromising the electrical conductivity of the conductive fabric. In another embodiment, the weave of fabric 240 may be aligned with the weft fibers extending along the length of the tape, in which case the tape will be extendable along its length. Intermediate orientations may also be used.

Suitable electrically-conductive stretchable fabrics may include stretchable fabrics with electrically-conductive fibers (e.g., stainless steel fibers) woven in with natural or synthetic non-conducting fibers made of, for example, nylon, polyester, cotton, polyolefin, rayon, acrylic). Useful electrically-conductive fiber fabrics also include fabrics made of fibers having a conductive (e.g., carbon, gold, copper, nickel, silver, titanium, or stainless steel) coating deposited on a base fiber (i.e., metallized fibers). Other electrically-conductive stretchable fabrics, including conductive scrims, may also be used. Preferably, the electrically-conductive stretchable fabric comprises a woven fabric with crimped fibers in at least one of the weft or warp directions. In some embodiments, the electrically-conductive stretchable fabric is elastic, although this is not a requirement.

In some embodiments, more than one electrically-conductive stretchable fabric may be included in the stretchable conductive tape; for example, separated from each other by an additional layer of electrically-conductive adhesive. In cases where more than one electrically-conductive stretchable fabric is included, the fabrics may be the same or different, and may have the same or different orientations.

Suitable electrically-conductive stretchable fabrics may be woven, nonwoven, or knit, for example, provided that they are capable of stretching (without breakage), preferably at least 5 percent (preferably at least 6 percent, at least 7 percent, at least 8 percent, at least 9 percent, at least 10 percent, at least 15 percent, or even at least 20 percent) elongation in the lengthwise and/or widthwise dimension of the stretchable electrically-conductive adhesive tape without suffering a significant loss of electrical conductivity (e.g., a loss of at least 10% in the electrical conductivity), or a significant resistivity increase (e.g., an increase of at least 10% in the resistivity), or a significant resistance increase with repeated flexing according to the Resistance Change of Conductive Tape with Mechanical Flexing Test Method hereinbelow, due to repeated flexing of the tape (e.g., caused by fiber breakage or electrically-conductive adhesive layer(s) deformation, or deformation of plated metals on the conductive fibers).

Suitable electrically-conductive particles include particulate polyaniline (e.g., see U.S. Pat. No. 5,645,764 (Angelopoulos et al.)); particulate metals such as silver, gold, stainless steel, or copper particles (e.g., see U.S. Pat. No. 3,475,213 (Stow) and U.S. Pat. No. 4,258,100 (Fujitano et al.)); and carbonyl nickel powder (e.g., see U.S. Pat. No. 3,762,946 (Stow et al.)); and metal-coated polymer particles as described in U. S. Pat. Appl. Publ. No. 2001/0295098 A1 (Hwang et al.).

Suitable electrically-conductive particles may include, for example, metal oxides such as antimony doped tin oxide, aluminum doped zinc oxide, and niobium doped titanium oxide; metals such as silver, copper, nickel, gold, tin and alloys thereof; metal-coated particles (e.g., silver, gold, or nickel coated particles) such as metal-coated polymer particles, metal-coated glass beads, metal coated glass flakes/fibers, and metal-coated nickel particles; carbon nanotubes, and graphite. When the conductive particles are soft (e.g., as described in U.S. Pat. No. 4,606,962 (Reylek)), moderate hand pressure applied to interconnecting electrodes can flatten the particles to provide a small, flat conductive area where each particle contacts another particle or an electrode.

The amount of electrically-conductive particles will generally depend on the size of the particles and the physical dimensions of the electrically-conductive stretchable fabric. Typical amounts are about 0.1 to about 50 percent by weight based on the total weight of the pressure-sensitive electrically-conductive adhesive layer. Within this range it is generally desirable to have an amount of greater than or equal to about 1 percent by weight, preferably greater than or equal to about 5 percent by weight of the total weight of the pressure-sensitive electrically-conductive adhesive layer. Also desirable is an amount of less than or equal to about 40 percent by weight, more preferably less than or equal to about 25 percent by weight, of the total weight of the pressure-sensitive electrically-conductive adhesive layer.

The electrically-conductive particle size and shape is not limited, and may include spheres, flakes, and irregularly shaped particles. Likewise, particle size is not limited, and may include sizes well below the thickness of the adhesive up to particles large enough to span the entire bondline thickness of the adhesive, for example. In some embodiments, the average diameter of the particles is approximately equal to the thickness of the adhesive between the surface of the adhesive and the conductive fabric.

As used herein, the term “electrically-conductive” means conductive of electricity, preferably having a bulk resistivity of less than 10⁹ ohms per centimeter at 20° C., more preferably having a bulk resistivity of less than 10³ ohms per centimeter at 20° C., more preferably having a bulk resistivity of less than 10 ohms per centimeter at 20° C., and even more preferably having a bulk resistivity of less than 0.1 ohm per centimeter at 20° C.

A variety of pressure-sensitive adhesive formulations may be suitable for use in the electrically-conductive pressure-sensitive adhesive layer. Examples include film-forming materials such as a natural or synthetic rubber or elastomer, or other resin, plastic, or polymer exhibiting rubber-like properties of compliancy, resiliency or compression deflection, low compression set, flexibility, and an ability to recover after deformation. Examples of such materials include styrene-butadiene block copolymers, styrene-isoprene copolymers, polybutadienes, polyisobutylenes, polyurethanes, silicones, fluorosilicones and other fluoropolymers, butyl rubber, neoprene, nitrile rubber, polyisoprenes, plasticized nylons, polyesters, polyvinyl ethers, polyvinyl acetates, polyisobutylenes, ethylene-vinyl acetate copolymers, polyolefins, and polyvinyl chlorides, copolymer rubbers such as ethylene-propylene rubber (EPR), ethylene-propylene-diene monomer (EPDM) rubber, styrene-isoprene-styrene (SIS) block copolymers, styrene-butadiene-styrene (SBS) block copolymers, nitrile-butadienes (NBR), styrene-butadiene block copolymers (SBR), and mixtures thereof.

These materials may be compounded with a tackifier, which may be a resin such as glyceryl esters of hydrogenated resins, thermoplastic terpene resins, petroleum hydrocarbon resins, coumarone-indene resins, synthetic phenol resins, low molecular weight polybutenes, or a tackifying silicone. Generally, the tackifying resin (if present) may be compounded into the resin material at between about 40-150 parts per hundred parts of the resin, although this is not a requirement.

Additional fillers and additives may also be included in the may be suitable for use in the electrically-conductive pressure-sensitive adhesive layer, for example, depending upon the requirements of the particular application, for example conventional wetting agents or surfactants, pigments, dyes, and other colorants, opacifying agents, antifoaming agents, anti-static agents, coupling agents such as titanates, chain extending oils, lubricants, stabilizers, emulsifiers, antioxidants, thickeners, and/or flame retardants such as aluminum trihydrate, antimony trioxide, metal oxides and salts, intercalated graphite particles, phosphate esters, brominated diphenyl compounds such as decabromodiphenyl oxide, borates, phosphates, halogenated compounds, glass, silica, silicates, and mica.

Typically, these fillers and additives are blended or otherwise admixed with the adhesive composition, in combination with the electrically-conductive particles and electrically-conductive stretchable fabric and may comprise between about 0.05-80 percent or more by total volume thereof.

Aqueous pressure-sensitive adhesive compositions suitable for use in the electrically conductive pressure-sensitive layer include, for example, those comprising a mechanically stable aqueous emulsion of polyethylene particles having an average molecular weight ranging from about 7,000 g/mol to about 40,000 g/mol as described in U.S. Pat. No. 3,734,686 (Douglas); ethylene polymer latexes containing ethylene polymer particles of submicron size prepared by dispersing in water an ethylene polymer and a water-soluble block copolymer of ethylene oxide and propylene oxide as described in U.S. Pat. No. 3,418,265 (McClain); latexes prepared from copolymers of ethylene and C₃-C₂₀ alpha-olefins as in U.S. Pat. No. 5,574,091 (Walther et al.); or compositions comprising homogenous ethylene/alpha-olefin copolymers and substantially random copolymers as disclosed in U.S. Pat. No. 6,521,696 (Oates et al.).

One useful type of acrylic pressure-sensitive adhesive composition is based on (meth)acrylates (i.e., inclusive of acrylates and/or methacrylates). Such compositions include, for example, copolymers derived from compositions containing, based on the total weight of the monomer components, about 50 to about 99 weight percent of C₄-C₁₈ alkyl esters of (meth)acrylic acids, about 1 to about 50 weight percent of polar ethylenically-unsaturated comonomers such as itaconic acid, certain substituted acrylamides such a N,N-dimethyl acrylamide, N-vinyl-2-pyrrolidone, or N-vinylcaprolactam, acrylonitrile, acrylic acid, glycidyl acrylate, and optionally, up to about 25 weight percent of a non-polar ethylenically-unsaturated comonomer such as cyclohexyl acrylate, n-octyl acrylamide, t-butyl acrylate, methyl methacrylate, and/or a tackifier.

Other additives such as crosslinking agents may also be present, for example, include di- and tri(meth)acrylates (e.g., 1,6-hexanediol diacrylate); and photoinitiators such as 1-hydroxycyclohexyl phenyl ketone or 2,2-dimethoxy-2-phenylacetophenone, which are commercially available from Ciba Specialty Chemicals, Tarrytown, N.Y. as IRGACURE 184 and IRGACURE 651, or other photoinitiators for ethylenically-unsaturated monomers which are well known in the art. Cross-linking agents and photoinitiators, are each generally used in an effective amount to cause curing, typically about 0.005 percent by weight to about 0.5 percent by weight, based on the total weight of monomers.

Suitable (meth)acrylate pressure sensitive-adhesives (i.e., acrylic PSAs) are disclosed, for example, in U.S. Pat. No. 4,223,067 (Levens); U.S. Pat. No. 4,181,752 (Martens et al.); U.S. Pat. No. 5,183,833 (Fisher et al.); U.S. Pat. No. 5,645,764 (Angelopoulos et al.), and Re. 24,906 (Ulrich). Suitable compositions are also commercially available, for example, from Ashland Chemicals, Columbus, Ohio, as AEROSET.

(Meth)acrylate-containing monomer mixtures may be polymerized by various techniques, preferably photoinitiated bulk polymerization as described, for example, in U.S. Pat. No. 5,620,795 (Haak et al.), wherein the polymerizable comonomers and a photoinitiator are mixed together in the absence of solvent and partially polymerized to a viscosity of about 500 cps (500 mPa-sec) to about 50000 cps (50000 mPa-sec) to achieve a coatable syrup. Alternatively, the monomers may be mixed with a thixotropic agent such as fumed hydrophilic silica to achieve a coatable thickness. A crosslinking agent, the carbon nanotubes, and any other components (including any tackifiers) are then added to the prepolymerized syrup. Alternatively, these components (including any tackifiers but with the exception of the crosslinking agent) can be added directly to the monomer mixture prior to pre-polymerization. The resulting composition is coated onto a substrate (which may be transparent to ultraviolet radiation) and polymerized in an inert (i.e., oxygen-free) atmosphere, e.g., a nitrogen atmosphere by exposure to ultraviolet radiation. Examples of suitable substrates include a release liners (e.g., silicone release liners) and the elastic tape backing (which may be primed or unprimed). A sufficiently inert atmosphere can also be achieved by covering a layer of the polymerizable coating with a plastic film which is substantially transparent to ultraviolet radiation, and irradiating through that film in air as described in U.S. Pat. No. 4,181,752 (Martens et al.) using ultraviolet lamps. The ultraviolet light source preferably has 90 percent of the emissions between 280 nm and 400 nm (more preferably between 300 nm and 400 nm), with a maximum at 351 nm.

In general, the electrically-conductive pressure-sensitive adhesive should be electrically-conductive in all directions, however the degree of conductivity may vary.

Useful elastic backings include fabrics and films of elastic materials. Examples of suitable elastic polymers (i.e., elastomers) include ethylene-vinyl acetate elastomers, ethylene-propylene elastomers, ethylene-propylene-diene-elastomers, styrene-butadiene elastomers, polybutadiene elastomers, nitrile elastomers, hydrogenated nitrile elastomers, polyisoprene elastomers, polyurethane elastomers, acrylonitrile-butadiene-styrene elastomers, ethylene-butyl acrylate elastomers, ethylene-acrylic elastomers, bromobutyl elastomers, and butyl elastomers modified with divinylbenzene. Of these, polyurethane elastomers are preferred. These elastomers are generally commercially available.

The elastic backing may be a uniform film, or it may be a composite film (e.g., having multiple layers produced by coextrusion, heat lamination, or adhesive bonding). In some preferred embodiments, the elastic backing comprises an elastic polyurethane film. Examples of elastomeric polyurethanes that may be used include, those available under the trade designation ESTANE from B.F. Goodrich & Co., Cleveland, Ohio, and those described in U.S. Pat. No. 2,871,218 (Schollenberger), U.S. Pat. No. 3,645,835 (Hodgson), U.S. Pat. No. 4,595,001 (Potter et al.), U.S. Pat. No. 5,088,483 (Heinecke), U.S. Pat. No. 6,838,589 (Liedtke et al.), and RE 33,353 (Heinecke). Useful pressure-sensitive adhesive coated polyurethane elastomer films are commercially available from 3M Company as TEGADERM.

The elastic backing is preferably from about 10 microns to about 1 millimeter in thickness, more preferably, from 10 to 20 microns in thickness; however, this is not a requirement.

In some embodiments, the elastic backing is elastically extensible by at least 10 percent, at least 50 percent, at least 100 percent, at least 150 percent, or even at least 200 percent, although this is not a requirement.

While the backing is elastic than provide a restorative force to the tape following deformation, the stretchable electrically-conductive adhesive tape need not be elastic itself (e.g., it may exhibit some hysteresis). Preferably, lengthwise and/or widthwise plastic deformation of the stretchable electrically-conductive adhesive tape is less than 10 percent, preferably less than 5, and more preferably less than 2 percent for lengthwise and/or widthwise tape stretching of 10 percent or less.

In some preferred embodiments, the elastic backing is colored (e.g., pigmented) for aesthetic appearance and/or light blocking properties.

Referring again to FIG. 1, optional release liner 160 may comprise any material suitable for use as a release layer optionally disposed on a backing (e.g., paper, polymer film, metal foil). Examples include face stocks or other films of polyolefins, plasticized polyvinyl chloride, polyesters, cellulosics, metal foils, composites, and waxed, siliconized, or other coated paper or plastic having a relatively low surface energy to be removable without appreciable lifting of the adhesive layer 110 from the elastic backing 150. Suitable release liners are release available from commercial sources and/or can be made by known methods.

The total thickness of the electrically-conductive pressure-sensitive adhesive tape (exclusive of any optional release liner) is preferably from 20 to 1000 microns, more preferably 30 to 200 microns, more preferably 40 microns to 150 microns, and even more preferably 45 to 80 microns, although other thickness may also be used.

The nominal conductivity of the stretchable electrically-conductive adhesive tape can vary based on the end application need. For example, the nominal conductivity of the tape according to a static (prior to flexing) resistance measurement in the Resistance Change of Conductive Tape with Mechanical Flexing Test Method is 100-100,000 ohms, preferably 10-100 ohms, most preferably 0.001 to 10 ohms for most electronics applications.

The variation of the conductivity when stretched or flexed in a cyclic manner is typically important to the material performance. For example, the nominal resistance variation as measured by the Resistance Change of Conductive Tape with Mechanical Flexing Test Method hereinbelow is preferably 0.001 to 100 times the nominal resistance value, more preferably 0.001 to 10 times the nominal resistance value, more preferably 0.001 to 1 times the nominal resistance value, and even more preferably 0.001 to 0.1 times the nominal resistance value.

Exemplary electronic articles that may include the stretchable electrically-conductive pressure-sensitive adhesive tapes of the present disclosure include LCD assemblies used in handheld tablet computers, smartphones, and folding laptop computers to name but a few.

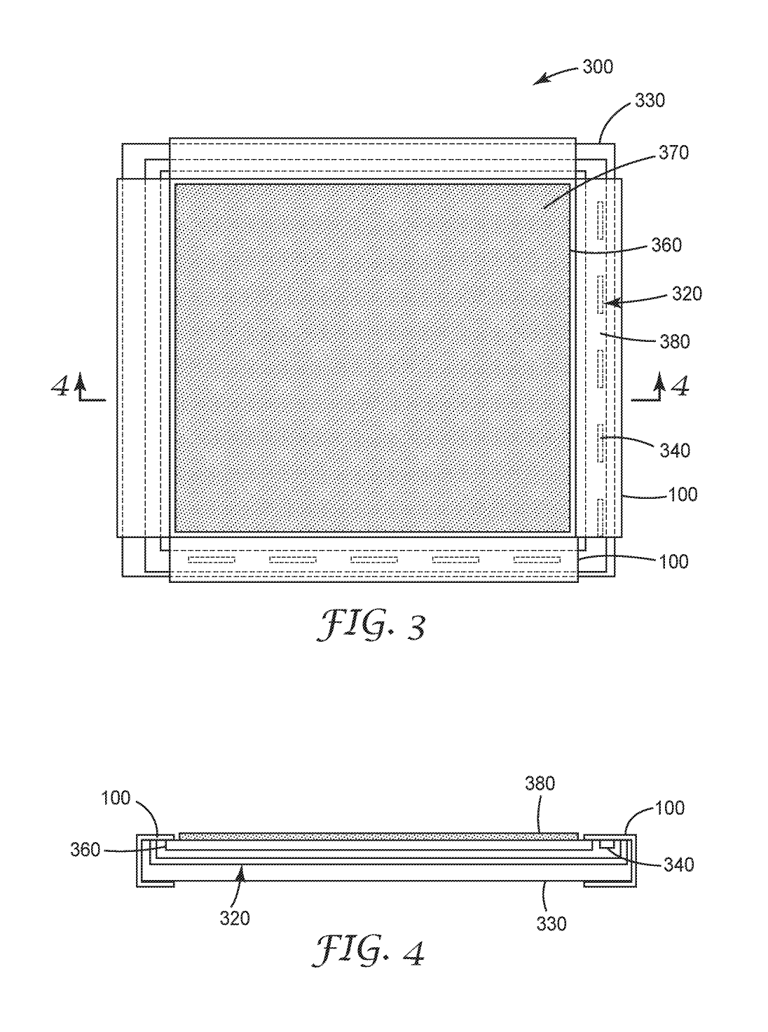

FIGS. 3 and 4 show an exemplary electronic article according to the present disclosure, in which liquid crystal display (LCD) assembly 300 includes a stretchable electrically-conductive adhesive tape 100 according to the present disclosure deployed as an edge wrap 310, thereby grounding various components (e.g., LCD 350, indium-tin-oxide (ITO) layer 360, and driver circuitry 340) of the liquid crystal (LCD) electronic display 320 to metal chassis 330 of the LCD assembly 300. Transparent hard coat 370 protects LCD glass 380 from environmental damage.

In electronic articles, the electrically-conductive pressure-sensitive adhesive tapes of the present disclosure may be useful for wrapping of liquid crystal display (LCD) components, EMI shielding and grounding, and protection of driver circuitry from electrostatic discharge (ESD) damage. They may also advantageously provide light shielding, chemical shielding, and function as an aesthetic transition.

### SELECT EMBODIMENTS OF THE PRESENT DISCLOSURE

In a first embodiment, the present disclosure provides a stretchable electrically-conductive adhesive tape comprising:

an electrically-conductive pressure-sensitive adhesive layer having first and second opposed major surfaces, wherein the electrically-conductive pressure-sensitive adhesive layer comprises electrically-conductive particles and an electrically-conductive stretchable fabric disposed within a polymer matrix, wherein the electrically-conductive pressure-sensitive adhesive layer is electrically-conductive in all directions; and

an elastic backing disposed on the first major surface of the electrically-conductive pressure-sensitive adhesive layer.

In a second embodiment, the present disclosure provides the stretchable electrically-conductive adhesive tape according to the first embodiment, wherein the electrically-conductive stretchable fabric comprises a woven fabric having crimped weft fibers.

In a third embodiment, the present disclosure provides a stretchable electrically-conductive adhesive tape according to the first or second embodiment, further comprising a release liner disposed on the second surface of the electrically-conductive pressure-sensitive adhesive layer.

In a fourth embodiment, the present disclosure provides a stretchable electrically-conductive adhesive tape according to any one of the first to third embodiments, further comprising a release coating disposed on the elastic backing opposite the electrically-conductive pressure-sensitive adhesive layer.

In a fifth embodiment, the present disclosure provides a stretchable electrically-conductive adhesive tape according to any one of the first to fourth embodiments, wherein the electrically-conductive pressure-sensitive adhesive layer is electrically-conductive in all directions.

In a sixth embodiment, the present disclosure provides a stretchable electrically-conductive adhesive tape according to any one of the first to fifth embodiments, wherein the electrically-conductive pressure-sensitive adhesive layer comprises an acrylic polymer.

In a seventh embodiment, the present disclosure provides a stretchable electrically-conductive adhesive tape according to any one of the first to sixth embodiments, wherein the elastic backing comprises an elastic polymer film.

In an eighth embodiment, the present disclosure provides a stretchable electrically-conductive adhesive tape according to any one of the first to seventh embodiments, wherein the elastic backing comprises an elastic polyurethane film.

In a ninth embodiment, the present disclosure provides a stretchable electrically-conductive adhesive tape according to any one of the first to eighth embodiments, wherein the elastic backing comprises an elastic electrically-conductive stretchable fabric.

In a tenth embodiment, the present disclosure provides a stretchable electrically-conductive adhesive tape according to any one of the first to ninth embodiments, wherein the elastic backing comprises an elastic electrically-conductive stretchable fabric and is XYZ conductive through the thickness of all of the tape layers combined.

In an eleventh embodiment, the present disclosure provides an electronic article comprising two electrically-conductive components in electrical communication through a stretchable electrically-conductive adhesive tape according to any one of the first to eighth embodiments.

In a twelfth embodiment, the present disclosure provides an electronic article according to the eleventh embodiment, wherein the stretchable electrically-conductive adhesive tape is disposed along at least one edge thereof.

In a thirteenth embodiment, the present disclosure provides an electronic article according to the eleventh or twelfth embodiment, wherein the electronic article comprises an LCD display assembly.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Resistance Change of Conductive Tape with Mechanical Flexing Test Method

A piece (25.4 mm×25.4 mm) of conductive tape is applied to a standard FR4 Printed Circuit Board material (1.6 mm thickness) across a pair of 25.4 mm by 2 mm electrodes spaced 25.4 mm apart in the middle of a 2 inches (5.1 cm) by 3 inches (7.6 cm) board. During the flexing tests, one of the 2 inches (5.1 cm) wide ends of the PCB is fixed in place such that the board is horizontally positioned while a 1 kg load is applied and removed for 400 cycles on the opposite end (resulting in a maximum downward deflection of 4.45 mm). A conventional multi-meter monitors the resistance across the tape samples during the cycling.

### Comparative Example A

Comparative Example A was an XYZ-axis Electrically Conductive Single-sided Fabric Tape 7750BF having a filled conductive acrylic adhesive and a 30 micron nickel/copper coated woven fabric from 3M Company, St. Paul, Minn.

### Example 1

This examples describes the preparation of an electrically-conductive adhesive tape.

### Preparation of Double-Sided Conductive Adhesive Tape:

An acrylic copolymer solution (390 parts) available as SEN-7000 (59% solids) from Geomyung Corp., Cheon-an, Korea was mixed with 5.85 parts of an isocyanate crosslinker available as GT75 (45% solids) from Geomyung Corp., 25 parts of nickel powder available as T123 from Vale Inco, Canada, and 150 parts of toluene. The components were mixed together using conventional high shear mixing. The resultant mixture was coated on a 25 micron thick siliconized polyester (PET) release liner using a notch bar, and then heated by passing the coated release liner through an oven, whereby solvent was removed and crosslinking of the acrylic copolymer occurred. The resultant pressure-sensitive adhesive layer thickness was 25 microns.

Two pieces of resultant PSA layer/release liner assembly were then laminated onto opposite sides of a stretchable electrically-conductive woven fabric having crimps in the weft yarns (available as D30-Chiffon from Ilheoung EMT, Daegu, Korea) by the adhesive coated PET liner on the both side of the fabric. The original fabric thickness of 150 microns was reduced by calendering to 90 microns prior to lamination of the adhesive layers.

The total thickness of metallized fabric and associated laminated adhesive layers (i.e., exclusive of the release liners) was 130 microns during to some migration of the adhesive into the fabric during lamination.

### Preparation of the Polyurethane-Coated Release Liner:

A polyurethane solution available as CH-L53 Black from Cheongwoo, Ansan, Korea was coated onto a 25 micron siliconized PET release liner using a notch bar. The coated liner was then dried by passing it through an oven resulting in a dry polyurethane film thickness of 20 microns.

### Preparation of Stretchable Conductive Adhesive Tape:

The dry polyurethane film prepared above was laminated to one side of the double-sided conductive adhesive tape prepared above. The release liner on the laminating side of the conductive adhesive was removed prior to laminating the polyurethane backing to the adhesive tape. The release liner on the polyurethane film backing was removed after laminating the urethane film on the double sided tape. The total thickness of the final structure was 150 microns (exclusive of release liner).

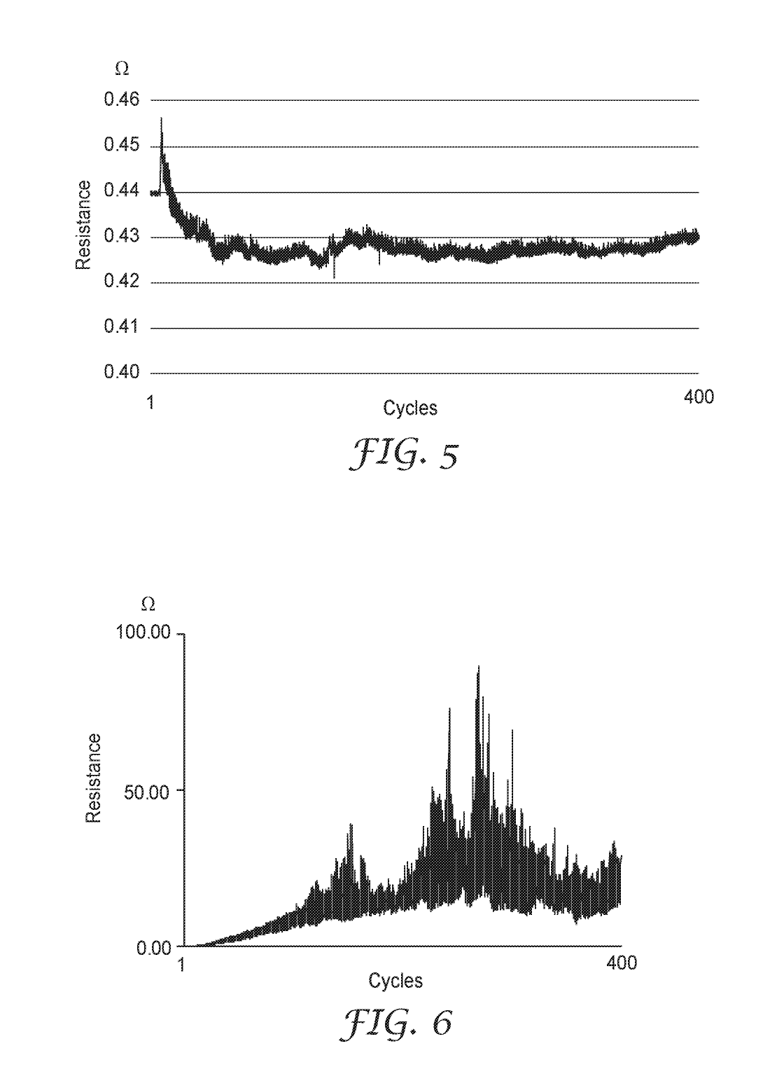

Tape samples from Example 1 and Comparative Example A were evaluated according to the Resistance Change of Conductive Tape with Mechanical Flexing Test Method hereinabove. Results are shown in FIG. 5 (Example 1) and FIG. 6 (Comparative Example A).

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A stretchable electrically-conductive adhesive tape comprising:
an electrically-conductive pressure-sensitive adhesive layer having first and second opposed major surfaces, wherein the electrically-conductive pressure-sensitive adhesive layer comprises electrically-conductive particles and an electrically-conductive stretchable fabric disposed within a polymer matrix, wherein the electrically-conductive pressure-sensitive adhesive layer is electrically-conductive in all directions; and
an elastic backing disposed on the first major surface of the electrically-conductive pressure-sensitive adhesive layer.

2. The stretchable electrically-conductive adhesive tape of claim 1, wherein the electrically-conductive stretchable fabric comprises a woven fabric having crimped weft fibers.

3. The stretchable electrically-conductive adhesive tape of claim 1, further comprising a release liner disposed on the second surface of the electrically-conductive pressure-sensitive adhesive layer.

4. The stretchable electrically-conductive adhesive tape of claim 1, further comprising a release coating disposed on the elastic backing opposite the electrically-conductive pressure-sensitive adhesive layer.

5. The stretchable electrically-conductive adhesive tape of claim 1, wherein the electrically-conductive pressure-sensitive adhesive layer is electrically-conductive in all directions.

6. The stretchable electrically-conductive adhesive tape of claim 1, wherein the electrically-conductive pressure-sensitive adhesive layer comprises an acrylic polymer.

7. The stretchable electrically-conductive adhesive tape of claim 1, wherein the elastic backing comprises an elastic polymer film.

8. The stretchable electrically-conductive adhesive tape of claim 1, wherein the elastic backing comprises an elastic polyurethane film.

9. The stretchable electrically-conductive adhesive tape of claim 1, wherein the elastic backing comprises an elastic electrically-conductive stretchable fabric.

10. The stretchable electrically-conductive adhesive tape of claim 1, wherein the elastic backing comprises an elastic electrically-conductive stretchable fabric and is XYZ conductive through the thickness of all of the tape layers combined.

11. An electronic article comprising two electrically-conductive components in electrical communication through the stretchable electrically-conductive adhesive tape of claim 1.

12. The electronic article of claim 11, wherein the stretchable electrically-conductive adhesive tape is disposed along at least one edge thereof.

13. The electronic article of claim 12, wherein the electronic article comprises an LCD display assembly.
